(19) United States
(12) Patent Application Publication
(10) Pub. No.: US 2026/0189886 A1
(43) Pub. Date: Jul. 2, 2026

(54) INFORMATION TRANSMISSION METHOD AND APPARATUS, AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/857,701

(22) PCT Filed: Apr. 19, 2022
(86) PCT No.: PCT/CN2022/087754

§ 371 Date: Oct. 17, 2024

(51) Int. Cl. H04W 4/40; H04W 36/08; H04W 76/20

(52) U.S. Cl. CPC H04W 4/40; H04W 36/08; H04W 76/20

(57) ABSTRACT

The present disclosure provides an information transmission method and apparatus, and a storage medium, where the information transmission method includes: reporting capability information to a base station through first radio resource control (RRC) signaling, where the capability information indicates whether the unmanned aerial vehicle supports reporting flight path information of the unmanned aerial vehicle.

### CROSS-REFERENCE TO RELATED APPLICATION

The present application is a U.S. National Stage of International Application No. PCT/CN2022/087754, filed on Apr. 19, 2022, the contents of which are incorporated herein by reference in their entirety.

### TECHNICAL FIELD

The present disclosure relates to the field of communications, and in particular, to an information transmission method and apparatus, and a storage medium.

### BACKGROUND

An unmanned aerial vehicle (UAV) is an unmanned aerial vehicle that is manipulated by using a radio remote control device and a self-contained program control apparatus. An unmanned aerial vehicle is actually a general term for unmanned aerial vehicles, and may be defined from a technical perspective as: an unmanned fixed-wing aircraft, an unmanned vertical take-off and landing aircraft, an unmanned airship, an unmanned helicopter, an unmanned multi-rotor aircraft, an unmanned umbrella wing aircraft, and the like.

With the rapid development of unmanned aerial vehicle technology, the reduction of cost and the improvement of function, unmanned aerial vehicles are increasingly applied to ordinary consumers. The applications of unmanned aerial vehicles to industry are the true need of unmanned aerial vehicles. At present, in the fields of aerial photography, agriculture, plant protection, miniature selfie, express transportation, disaster rescue, observation of wild animals, monitoring infectious diseases, surveying and mapping, news reporting, electric power inspection, disaster relief, film and television shooting, creating romance, and the like, the application of the unmanned aerial vehicle itself is greatly expanded, and all countries are actively expanding industry application and developing unmanned aerial vehicle technologies.

In order to further expand the application range of the unmanned aerial vehicle, the 3rd Generation Partnership Project (3GPP) approved the project of Enhanced Support for Aerial Vehicles. It is intended to study and standardize how to make cellular networks provide services that meet the needs of unmanned aerial vehicles.

Unmanned aerial vehicles typically have two flight modes. One is a fixed mode, that is, an operator plans a flight route of the unmanned aerial vehicle on a controller, so that the unmanned aerial vehicle can fly according to the planned route, and the controller does not need to control the unmanned aerial vehicle regularly. The other mode is a dynamic mode, that is, the controller may remotely control the unmanned aerial vehicle in real time through the controller. For the fixed mode, since the flight route and trajectory of the UAV are fixed, the cellular network may pre-judge which cellular network base stations the UAV will pass through.

Therefore, how to efficiently report flight path information by the unmanned aerial vehicle is an urgent problem to be resolved.

### SUMMARY

In order to overcome the problems existing in the related art, embodiments of the present disclosure provide information transmission methods and apparatuses, and storage media.

According to a first aspect of an embodiment of present disclosure, an information transmission method is provided, which is performed by an unmanned aerial vehicle, and the method includes: reporting capability information to a base station through first radio resource control (RRC) signaling, where the capability information indicates whether the unmanned aerial vehicle supports reporting flight path information of the unmanned aerial vehicle.

In some examples, the reporting capability information to a base station through first RRC signaling includes: reporting the capability information to the base station through a first information element in the first RRC signaling.

In some examples, the first RRC signaling is user equipment-evolved universal terrestrial radio access-capability (UE-EUTRA-Capability) signaling, and the first information element is an OtherParameters information element; or the first RRC signaling is user equipment-new radio-capability (UE-NR-Capability) signaling, and the first information element is an OtherParameters information element.

In some examples, the method further includes: receiving second RRC signaling sent by the base station, where the second RRC signaling carries configuration information for the unmanned aerial vehicle to report the flight path information.

In some examples, the configuration information indicates at least one of: whether the unmanned aerial vehicle is allowed to report the flight path information; a condition for reporting the flight path information; a format for reporting the flight path information; or a maximum number of path points allowed to be reported.

In some examples, the configuration information is carried in a second information element of the second RRC signaling.

In some examples, the second RRC signaling is RRC Connection Reconfiguration (RRCConnectionReconfiguration) signaling, and the second information element is an other configuration (OtherConfig) information element; or the second RRC signaling is RRC Reconfiguration (RRCReconfiguration) signaling, and the second information element is an other configuration (OtherConfig) information element.

In some examples, the method further includes: when the configuration information indicates that the unmanned aerial vehicle is allowed to report the flight path information, reporting, based on the configuration information, the flight path information to the base station through third RRC signaling.

In some examples, the reporting the flight path information to the base station through third RRC signaling includes: reporting the flight path information to the base station through a third information element in the third RRC signaling.

In some examples, the reporting the flight path information to the base station through third RRC signaling includes: reporting flight path information corresponding to a first number of path points through the third RRC signaling; where the first number of path points is a smaller one of a total number of path points on a flight path of the unmanned aerial vehicle and the maximum number of path points.

In some examples, when the total number of path points is greater than the maximum number of path points, the third RRC signaling includes indication information to indicate that the unmanned aerial vehicle does not report all flight path information.

In some examples, the indication information is carried in a third information element of the third RRC signaling.

In some examples, the third RRC signaling is user equipment assistance information (UEAssistanceInformation) signaling, and the third information element is a flight path information report (flightPathInfoReport) information element.

In some examples, the method further includes: reporting flight path information corresponding to a second number of path points to the base station through new third RRC signaling, where the second number of path points is a difference between the total number of path points and the maximum number of path points.

According to a second aspect of an embodiment of present disclosure, an information transmission method is provided, which is performed by a base station, and the method includes: receiving capability information reported by an unmanned aerial vehicle through first radio resource control (RRC) signaling, where the capability information indicates whether the unmanned aerial vehicle supports reporting flight path information of the unmanned aerial vehicle.

In some examples, the receiving capability information reported by an unmanned aerial vehicle through first RRC signaling includes: receiving the capability information reported by the unmanned aerial vehicle through a first information element in the first RRC signaling.

In some examples, the first RRC signaling is user equipment-evolved universal terrestrial radio access-capability (UE-EUTRA-Capability) signaling, and the first information element is an OtherParameters information element; or the first RRC signaling is user equipment-new radio-capability (UE-NR-Capability) signaling, and the first information element is an OtherParameters information element.

In some examples, the method further includes: when the capability information indicates that the unmanned aerial vehicle supports reporting the flight path information, sending second RRC signaling to the unmanned aerial vehicle, where the second RRC signaling carries configuration information for the unmanned aerial vehicle to report the flight path information.

In some examples, the configuration information indicates at least one of: whether the unmanned aerial vehicle is allowed to report the flight path information; a condition for reporting the flight path information; a format for reporting the flight path information; or a maximum number of path points allowed to be reported.

In some examples, the configuration information is carried in a second information element of the second RRC signaling.

In some examples, the second RRC signaling is RRC Connection Reconfiguration (RRCConnectionReconfiguration) signaling, and the second information element is an other configuration (OtherConfig) information element; or the second RRC signaling is RRC Reconfiguration (RRCReconfiguration) signaling, and the second information element is an other configuration (OtherConfig) information element.

In some examples, the method further includes: receiving the flight path information reported by the unmanned aerial vehicle through third RRC signaling.

In some examples, receiving the flight path information reported by the unmanned aerial vehicle through third RRC signaling includes: receiving the flight path information reported by the unmanned aerial vehicle through a third information element in the third RRC signaling.

In some examples, the method further includes: in response to receiving the flight path information reported by the unmanned aerial vehicle, executing a target operation, where the target operation at least includes an inter-base station handover preparation operation.

In some examples, the method further includes: in response to determining that the third RRC signaling includes indication information, not executing a target operation, where the indication information indicates that the unmanned aerial vehicle does not report all flight path information, and the target operation at least includes an inter-base station handover preparation operation; and waiting to receive flight path information corresponding to a second number of path points reported by the unmanned aerial vehicle through new third RRC signaling, where the second number of path points is a difference between a total number of path points on a flight path of the unmanned aerial vehicle and the maximum number of path points.

In some examples, the method further includes: in response to receiving flight path information corresponding to the total number of path points reported by the unmanned aerial vehicle, executing the target operation.

In some examples, the indication information is carried in a third information element of the third RRC signaling.

In some examples, the third RRC signaling is user equipment assistance information (UEAssistanceInformation) signaling, and the third information element is a flight path information report (flightPathInfoReport) information element.

According to a third aspect of an embodiment of present disclosure, an information transmission apparatus is provided, which is applied to an unmanned aerial vehicle, including: a reporting module, configured to report capability information to a base station through first radio resource control (RRC) signaling, where the capability information indicates whether the unmanned aerial vehicle supports reporting flight path information of the unmanned aerial vehicle.

According to a fourth aspect of an embodiment of present disclosure, an information transmission apparatus is provided, which is applied to a base station, including: a receiving module, configured to receive capability information reported by an unmanned aerial vehicle through first radio resource control (RRC) signaling, where the capability information indicates whether the unmanned aerial vehicle supports reporting flight path information of the unmanned aerial vehicle.

According to a fifth aspect of an embodiment of the present disclosure, a computer-readable storage medium is provided, where the storage medium stores a computer program for executing any one of the information transmission methods on the unmanned aerial vehicle side.

According to a sixth aspect of an embodiment of the present disclosure, a computer-readable storage medium is provided, where the storage medium stores a computer program for executing any one of the information transmission methods on the base station side.

According to a seventh aspect of an embodiment of the present disclosure, an information transmission apparatus is provided, including: a processor; and a memory, configured to store processor-executable instructions; where the processor is configured to execute any of the information transmission methods described above on the unmanned aerial vehicle side.

According to an eighth aspect of an embodiment of the present disclosure, an information transmission apparatus is provided, including: a processor; and a memory, configured to store processor-executable instructions; where the processor is configured to execute any of the information transmission methods described above on the base station side.

The technical solutions provided by the embodiments of the present disclosure can include the following beneficial effects.

In the embodiment of the present disclosure, the UAV can report capability information to the base station, which indicates whether the UAV supports reporting the flight path information of the UAV. After receiving the capability information, the base station can configure the UAV to report the flight path information, and the UAV can subsequently report the flight path information based on the configuration of the base station, which improves the efficiency of reporting the flight path information of the UAV, and has simple implementation and high usability.

It should be understood that the above general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a flowchart of an information transmission method according to an embodiment of the present disclosure.

FIG. 2 is a flowchart of another information transmission method according to an embodiment of the present disclosure.

FIG. 3 is a flowchart of another information transmission method according to an embodiment of the present disclosure.

FIG. 4 is a flowchart of another information transmission method according to an embodiment of the present disclosure.

FIG. 5 is a flowchart of another information transmission method according to an embodiment of the present disclosure.

FIG. 6 is a flowchart of another information transmission method according to an embodiment of the present disclosure.

FIG. 7 is a flowchart of another information transmission method according to an embodiment of the present disclosure.

FIG. 8 is a flowchart of another information transmission method according to an embodiment of the present disclosure.

FIG. 9 is a flowchart of another information transmission method according to an embodiment of the present disclosure.

FIG. 10A is a flowchart of another information transmission method according to an embodiment of the present disclosure.

FIG. 10B is a flowchart of another information transmission method according to an embodiment of the present disclosure.

FIG. 11 is a block diagram of an information transmission apparatus according to an embodiment of the present disclosure.

FIG. 12 is a block diagram of another information transmission apparatus according to an embodiment of the present disclosure.

FIG. 13 is a structural schematic diagram of an information transmission apparatus according to an embodiment of the present disclosure of the present disclosure.

FIG. 14 is a structural schematic diagram of another information transmission apparatus according to an embodiment of the present disclosure of the present disclosure.

### DETAILED DESCRIPTION

Reference will now be made in detail to exemplary embodiments, examples of which are illustrated in the accompanying drawings. When the following description refers to the accompanying drawings, unless otherwise indicated, the same numbers in different accompanying drawings indicate the same or similar elements. Implementations described in the following exemplary embodiments do not represent all implementations consistent with the present disclosure. Rather, they are merely examples of apparatuses and methods consistent with some aspects of the present disclosure as detailed in the appended claims.

Terms used in the present disclosure are only for a purpose of describing specific embodiments, and are not limiting the present disclosure. Singular forms of “a,” said,” and “the” used in the present disclosure and in the claims are also intended to include majority forms, unless the context clearly indicates otherwise. It should also be understood that the term “and/or” as used herein refers to any or all of the possible combinations containing at least one of the listed items in association.

It should be understood that although terms first, second, third, etc. may be used to describe various information in the present disclosure, these information should not be limited to these terms. These terms are used only to distinguish the same type of information from one another. For example, without departing from the scope of the present disclosure, first information can also be called second information, and similarly, the second information can also be called the first information. Depending on the context, the word “if” as used herein can be interpreted as “at” or “when” or “in response to determining”.

Next, the information transmission method provided by the present disclosure will be introduced from an unmanned aerial vehicle side.

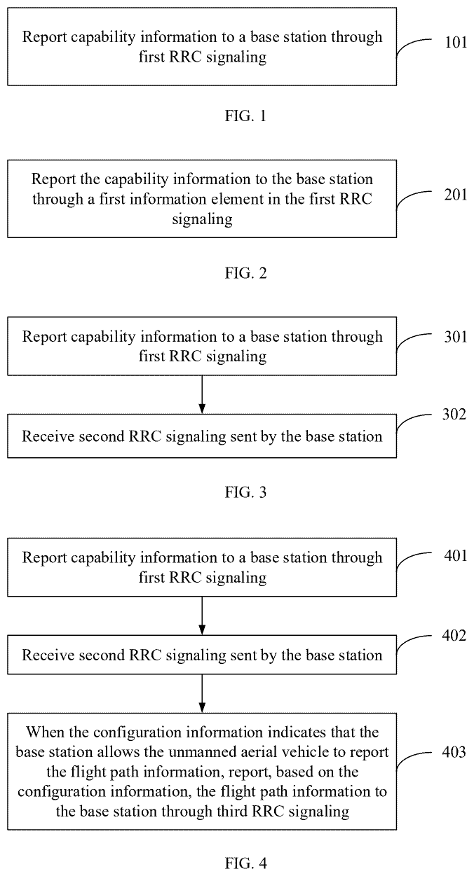

An embodiment of the present disclosure provides an information transmission method, referring to FIG. 1, FIG. 1 is a flowchart of an information transmission method according to an embodiment, which can be performed by an unmanned aerial vehicle, and the method may include step 101.

At step 101, capability information is reported to a base station through first radio resource control (RRC) signaling.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, which is not limited by the present disclosure.

In a possible implementation, the first RRC signaling reuses the existing RRC signaling in the protocol. In case of a long term evolution (LTE) network, the first RRC signaling can be user equipment-evolved universal terrestrial radio access-capability (UE-EUTRA-Capability) signaling.

In another possible implementation, the first RRC signaling reuses the existing RRC signaling in the protocol. In case of a new radio (NR) network, the first RRC signaling can be user equipment-new radio-capability (UE-NR-Capability) signaling.

Thus, the UAV can report the capability information to the base station, which indicates whether the UAV supports reporting the flight path information of the UAV. After receiving the capability information, the base station can configure the UAV to report the flight path information based on the capability information, which improves the efficiency of reporting the flight path information of the UAV, and is simple to implement and high in usability.

In some embodiments, with reference to FIG. 2, FIG. 2 is a flowchart of an information transmission method according to an embodiment, which can be performed by an unmanned aerial vehicle, and the method may include step 201.

At step 201, the capability information is reported to the base station through a first information element in the first RRC signaling.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, and the first information element can reuse an existing information element in the existing RRC signaling, or the first information element is a newly defined information element in the existing RRC signaling or the newly defined RRC signaling, which is not limited by the present disclosure.

In a possible implementation, the first RRC signaling can reuse the existing RRC signaling in the protocol, and the first information element can reuse the existing information element in the existing RRC signaling, and in case of the LTE network, the first RRC signaling can be UE-EUTRA-Capability signaling, and the first information element can be an OtherParameters information element in the UE-EUTRA-Capability signaling.

In another possible implementation, the first RRC signaling can reuse the existing RRC signaling in the protocol, and the first information element can reuse the existing information element in the existing RRC signaling, and in case of the LTE network, the first RRC signaling can be UE-NR-Capability signaling, and the first information element can be an OtherParameters information element in the UE-NR-Capability signaling.

Thus, the UAV can report the capability information to the base station, which indicates whether the UAV supports reporting the flight path information of the UAV. After receiving the capability information, the base station can configure the UAV to report the flight path information based on the capability information, which improves the efficiency of reporting the flight path information of the UAV, and is simple to implement and high in usability.

In some embodiments, with reference to FIG. 3, FIG. 3 is a flowchart of an information transmission method according to an embodiment, which can be performed by an unmanned aerial vehicle, and the method may include steps 301 and 302.

At step 301, capability information is reported to a base station through first radio resource control (RRC) signaling.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, which is not limited by the present disclosure.

At step 302, second RRC signaling sent by the base station is received.

In the embodiment of the present disclosure, the base station determines that the unmanned aerial vehicle supports reporting the flight path information based on the capability information, and sends second RRC signaling to the unmanned aerial vehicle, where the second RRC signaling carries configuration information for the unmanned aerial vehicle to report the flight path information. The second RRC signaling can reuse existing RRC signaling in a protocol or use newly defined RRC signaling in the protocol, which is not limited by the present disclosure.

In a possible implementation, the second RRC signaling reuses the existing RRC signaling in the protocol, and in case of the LTE network, the second RRC signaling can be RRC Connection Reconfiguration (RRCConnectionReconfiguration) signaling.

In another possible implementation, the second RRC signaling reuses the existing RRC signaling in the protocol, and in case of the NR network, the second RRC signaling can be RRC Reconfiguration (RRCReconfiguration) signaling.

Thus, after the UAV reports the capability information, it can receive the configuration information sent by the base station through the second RRC signaling, and the configuration information can be used to configure the UAV to report the flight path information, which improves the efficiency of reporting the flight path information of the UAV, and is simple to implement and high in usability.

In some embodiments, the configuration information indicates at least one of: whether the unmanned aerial vehicle is allowed to report the flight path information; a condition for reporting the flight path information; a format for reporting the flight path information; or a maximum number of path points allowed to be reported.

The base station can determine, according to its own capabilities, whether to allow the unmanned aerial vehicle to report the flight path information.

The condition for reporting the flight path information may include, but are not limited to, a duration of a blocking timer set for the unmanned aerial vehicle. The unmanned aerial vehicle starts the blocking timer after reporting the flight path information every time, and will not report the flight path information again until the blocking timer finishes. Thus, avoiding the waste of signaling resources caused by frequent reporting of flight path information by the unmanned aerial vehicle.

The maximum number of path points allowed to be reported can be determined by the base station in combination with its own capabilities to determine the maximum number of path points allowed to be reported by the unmanned aerial vehicle.

It should be noted that the flight path information of the unmanned aerial vehicle corresponds to at least one path point, i.e., in order to ensure that the unmanned aerial vehicle flies according to a specified route, at least one path point needs to be determined on the flight path, and the unmanned aerial vehicle must pass through this path point when flying.

Thus, the flight path information reported by the unmanned aerial vehicle can be configured by the base station based on the capability information reported by the unmanned aerial vehicle, and the usability is high.

In some embodiments, the configuration information may be carried in a second information element of the second RRC signaling. The second RRC signaling can reuse existing RRC signaling in a protocol or use newly defined RRC signaling in the protocol, and the second information element can reuse an existing information element in the existing RRC signaling, or the second information element is a newly defined information element in the existing RRC signaling or the newly defined RRC signaling, which is not limited by the present disclosure.

In a possible implementation, the second RRC signaling reuses the existing RRC signaling in the protocol, and the second information element can reuse the existing information element in the existing RRC signaling, and in case of the LTE network, the second RRC signaling can be the RRCConnectionReconfiguration signaling, and the second information element can be an other configuration (OtherConfig) information element in the RRCConnectionReconfiguration signaling.

In another possible implementation, the second RRC signaling reuses the existing RRC signaling in the protocol, and the second information element can reuse the existing information element in the existing RRC signaling, and in case of the NR network, the second RRC signaling can be the RRCReconfiguration signaling, and the second information element can be an OtherConfig information element in the RRCReconfiguration signaling.

In some embodiments, with reference to FIG. 4, FIG. 4 is a flowchart of an information transmission method according to an embodiment, which can be performed by an unmanned aerial vehicle, and the method may include steps 401-403.

At step 401, capability information is reported to a base station through first radio resource control (RRC) signaling.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, which is not limited by the present disclosure.

In a possible implementation, the first RRC signaling can reuse the existing RRC signaling in the protocol, and in case of the LTE network, the first RRC signaling can be UE-EUTRA-Capability signaling.

In another possible implementation, the first RRC signaling can reuse the existing RRC signaling in the protocol, and in case of the NR network, the first RRC signaling can be UE-NR-Capability signaling.

At step 402, second RRC signaling sent by the base station is received.

In an embodiment of the present disclosure, the base station determines that the unmanned aerial vehicle supports reporting the flight path information based on the capability information, and sends second RRC signaling to the unmanned aerial vehicle, where the second RRC signaling carries configuration information for the unmanned aerial vehicle to report the flight path information. The second RRC signaling can reuse existing RRC signaling in a protocol or use newly defined RRC signaling in the protocol, which is not limited by the present disclosure.

In a possible implementation, the second RRC signaling reuses the existing RRC signaling in the protocol, and in case of the LTE network, the second RRC signaling can be RRCConnectionReconfiguration signaling.

In another possible implementation, the second RRC signaling reuses the existing RRC signaling in the protocol, and in case of the NR network, the second RRC signaling can be RRCReconfiguration signaling.

At step 403, when the configuration information indicates that the base station allows the unmanned aerial vehicle to report the flight path information, the flight path information is reported to the base station through third RRC signaling based on the configuration information.

The third RRC signaling can reuse existing RRC signaling in a protocol or use newly defined RRC signaling in the protocol.

In a possible implementation, the third RRC signaling reuses the existing RRC signaling in the protocol, and in case of the LTE network or the NR network, the third RRC signaling can be user equipment assistance information (UEAssistanceInformation) signaling.

Thus, when the UAV determines that the base station supports the reporting of flight path information according to the configuration information sent by the base station, the UAV reports the flight path information to the base station based on the configuration information, which improves the efficiency of reporting the flight path information of the UAV, and is simple to implement and high in usability.

In some embodiments, the UAV may report the flight path information to the base station through a third information element in the third RRC signaling. The third RRC signaling can reuse existing RRC signaling in a protocol or use newly defined RRC signaling in the protocol, and the third information element can reuse an existing information element in the existing RRC signaling, or the third information element is a newly defined information element in the existing RRC signaling or the newly defined RRC signaling, which is not limited by the present disclosure.

In a possible implementation, the third RRC signaling can reuse the existing RRC signaling in the protocol, and the third information element can reuse the existing information element in the existing RRC signaling, and in case of the LTE network or the NR network, the third RRC signaling can be UEAssistantInformation signaling, and the third information element can be a flight path information report (flightPathInfoReport) information element in the UEAssistantInformation signaling.

In some embodiments, with reference to FIG. 5, FIG. 5 is a flowchart of an information transmission method according to an embodiment, which can be performed by an unmanned aerial vehicle, and the method may include steps 501-504.

At step 501, capability information is reported to a base station through first radio resource control (RRC) signaling.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, which is not limited by the present disclosure.

In a possible implementation, the first RRC signaling reuses the existing RRC signaling in the protocol, and in case of the LTE network, the first RRC signaling can be the UE-EUTRA-Capability signaling.

In another possible implementation, the first RRC signaling reuses the existing RRC signaling in the protocol. If it is an NR network, the first RRC signaling UE-NR-Capability signaling.

At step 502, second RRC signaling sent by the base station is received.

In the embodiment of the present disclosure, the base station determines that the unmanned aerial vehicle supports reporting the flight path information based on the capability information, and sends second RRC signaling to the unmanned aerial vehicle, where the second RRC signaling carries configuration information for the unmanned aerial vehicle to report the flight path information. The second RRC signaling can reuse existing RRC signaling in a protocol or use newly defined RRC signaling in the protocol, which is not limited by the present disclosure.

In a possible implementation, the second RRC signaling reuses the existing RRC signaling in the protocol, and in case of the LTE network, the second RRC signaling can be RRCConnectionReconfiguration signaling.

In another possible implementation, the second RRC signaling reuses the existing RRC signaling in the protocol, and in case of the NR network, the second RRC signaling can be RRCReconfiguration signaling.

At step 503, when the configuration information indicates that the base station allows the unmanned aerial vehicle to report the flight path information, flight path information corresponding to a first number of path points is reported through third RRC signaling based on the configuration information.

In the embodiment of the present disclosure, the first number of path points is a smaller one of a total number of path points on a flight path of the unmanned aerial vehicle and the maximum number of path points.

That is, when the total number of path points is less than or equal to the maximum number of path points that can be reported by the unmanned aerial vehicle, the unmanned aerial vehicle can report flight path information corresponding to the total number of path points to the base station, and when the total number of path points is greater than the maximum number of path points that can be reported by the UAV, the UAV can report flight path information corresponding to the maximum number of path points that can be reported by the UAV to the base station, and at this time, there are still flight path information corresponding to a part of number of path points that have not been reported to the base station, and the flight path information corresponding to the remaining number of path points can be reported in the subsequent process.

In a possible implementation, if the total number of path points on the flight path of the unmanned aerial vehicle is greater than the maximum number of path points indicated by the configuration information, the third RRC signaling may include indication information. The indication information indicates that the unmanned aerial vehicle does not report all flight path information.

Specifically, the indication information can be realized by adding an indication bit, and in some examples, the indication bit can be added in a third information element of the third RRC signaling, so as to inform the base station that the unmanned aerial vehicle has not reported all flight path information.

The third RRC signaling reuses the existing RRC signaling in the protocol, and the third information element reuses the existing information element in the existing RRC signaling, the third RRC signaling is UEAssistantInformation signaling, and the third information element can be a flightPathInfoReport information element in the UEAssistantInformation signaling.

At step 504, flight path information corresponding to a second number of path points is reported to the base station through new third RRC signaling.

The second number of path points is a difference between the total number of path points and the maximum number of path points. Similarly, flight path information corresponding to the number of second path points can be added to a third information element of the new third RRC signaling.

The new third RRC signaling is also UEAssistantInformation signaling, and the third information element can be a flightPathInfoReport information element in the UEAssistantInformation signaling.

It should be noted that step 504 is an optional execution step, and step 504 can be omitted if the total number of path points is less than or equal to the maximum number of path points.

Thus, the UAV can report the flight path information pertinently based on the configuration of the base station, which improves the efficiency of reporting the flight path information of the UAV, and is simple to implement and high in usability.

Next, the information transmission method provided by the present disclosure will be introduced from a base station side.

An embodiment of the present disclosure provides an information transmission method, referring to FIG. 6, FIG. 6 is a flowchart of an information transmission method according to an embodiment, which can be performed by a base station, and the method may include step 601.

At step 601, capability information reported by an unmanned aerial vehicle through first radio resource control (RRC) signaling is received.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, which is not limited by the present disclosure.

In a possible implementation, the first RRC signaling reuses the existing RRC signaling in the protocol, and in case of the LTE network, the first RRC signaling can be the UE-EUTRA-Capability signaling.

In another possible implementation, the first RRC signaling reuses the existing RRC signaling in the protocol. If it is an NR network, the first RRC signaling UE-NR-Capability signaling.

Thus, the base station can receive the capability information reported by the unmanned aerial vehicle, and determine whether the unmanned aerial vehicle supports reporting the flight path information based on the capability information, which is simple to implement and high in usability.

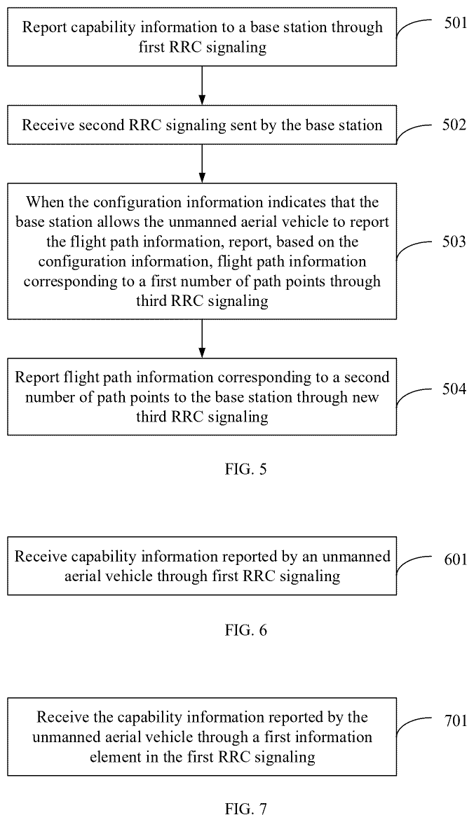

In some embodiments, with reference to FIG. 7, FIG. 7 is a flowchart of an information transmission method according to an embodiment, which can be performed by a base station, and the method may include step 701.

At step 701, the capability information reported by the unmanned aerial vehicle through a first information element in the first RRC signaling is received.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, and the first information element can reuse an existing information element in the existing RRC signaling, or the first information element is a newly defined information element in the existing RRC signaling or the newly defined RRC signaling, which is not limited by the present disclosure.

In a possible implementation, the first RRC signaling can reuse the existing RRC signaling in the protocol, and the first information element can reuse the existing information element in the existing RRC signaling, and in case of the LTE network, the first RRC signaling can be UE-EUTRA-Capability signaling, and the first information element can be an OtherParameters information element in the UE-EUTRA-Capability signaling.

In another possible implementation, the first RRC signaling can reuse the existing RRC signaling in the protocol, and the first information element can reuse the existing information element in the existing RRC signaling, and in case of the LTE network, the first RRC signaling can be UE-NR-Capability signaling, and the first information element can be an OtherParameters information element in the UE-NR-Capability signaling.

Thus, the base station can receive the capability information reported by the unmanned aerial vehicle through the first information element of the first RRC signaling, which is simple to implement and high in availability.

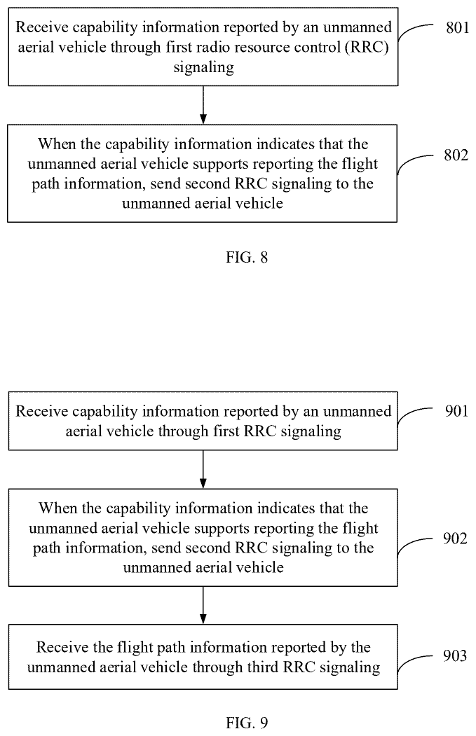

In some embodiments, with reference to FIG. 8, FIG. 8 is a flowchart of an information transmission method according to an embodiment, which can be performed by a base station, and the method may include steps 801 and 802.

At step 801, capability information reported by an unmanned aerial vehicle through first radio resource control (RRC) signaling is received.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, which is not limited by the present disclosure.

At step 802, when the capability information indicates that the unmanned aerial vehicle supports reporting the flight path information, second RRC signaling is sent to the unmanned aerial vehicle.

In the embodiment of the present disclosure, the base station determines that the unmanned aerial vehicle supports reporting the flight path information based on the capability information, and sends the second RRC signaling. The second RRC signaling carries configuration information for the unmanned aerial vehicle to report the flight path information. The second RRC signaling can reuse existing RRC signaling in a protocol or use newly defined RRC signaling in the protocol, which is not limited by the present disclosure.

In a possible implementation, the second RRC signaling reuses the existing RRC signaling in the protocol, and in case of the LTE network, the second RRC signaling can be RRCConnectionReconfiguration signaling.

In another possible implementation, the second RRC signaling reuses the existing RRC signaling in the protocol, and in case of the NR network, the second RRC signaling can be RRCReconfiguration signaling.

Thus, after the UAV reports the capability information, the base station can send the configuration information through the second RRC signaling, and the configuration information can be used to configure the UAV to report the flight path information, which improves the efficiency of reporting the flight path information of the UAV, and is simple to implement and high in usability.

In some embodiments, with reference to FIG. 9, FIG. 9 is a flowchart of an information transmission method according to an embodiment, which can be performed by a base station, and the method may include steps 901-903.

At step 901, capability information reported by an unmanned aerial vehicle through first radio resource control (RRC) signaling is received.

In the embodiment of the present disclosure, the capability information indicates whether the unmanned aerial vehicle supports reporting flight path information of the unmanned aerial vehicle. The first RRC signaling can reuse existing RRC signaling in a protocol or use newly defined RRC signaling in the protocol, which is not limited by the present disclosure.

In a possible implementation, the first RRC signaling can reuse the existing RRC signaling in the protocol, and in case of the LTE network, the first RRC signaling can be UE-EUTRA-Capability signaling.

In another possible implementation, the first RRC signaling can reuse the existing RRC signaling in the protocol, and in case of the NR network, the first RRC signaling can be UE-NR-Capability signaling.

At step 902, when the capability information indicates that the unmanned aerial vehicle supports reporting the flight path information, second RRC signaling is sent to the unmanned aerial vehicle.

In the embodiment of the present disclosure, the second RRC signaling carries configuration information for the unmanned aerial vehicle to report the flight path information. The second RRC signaling can reuse existing RRC signaling in a protocol or use newly defined RRC signaling in the protocol, which is not limited by the present disclosure.

In a possible implementation, the second RRC signaling reuses the existing RRC signaling in the protocol, and in case of the LTE network, the second RRC signaling can be RRCConnectionReconfiguration signaling.

In another possible implementation, the second RRC signaling reuses the existing RRC signaling in the protocol, and in case of the NR network, the second RRC signaling can be RRCReconfiguration signaling.

At step 903, the flight path information reported by the unmanned aerial vehicle through third RRC signaling is received.

In the embodiment of the present disclosure, if the unmanned aerial vehicle determines, based on the configuration information, that the base station allows to report the flight path information, it can report the flight path information to the base station through the third RRC signaling.

The third RRC signaling can reuse existing RRC signaling in a protocol or use newly defined RRC signaling in the protocol.

In a possible implementation, the third RRC signaling reuses the existing RRC signaling in the protocol, and in case of the LTE network or the NR network, the third RRC signaling can be user equipment assistance information (UEAssistanceInformation) signaling.

Thus, the base station sends the configuration information to the UAV, so that the UAV can report the flight path information to the base station through the third RRC signaling based on the configuration information, which improves the efficiency of reporting the flight path information of the UAV, is simple and convenient to implement, and has high usability.

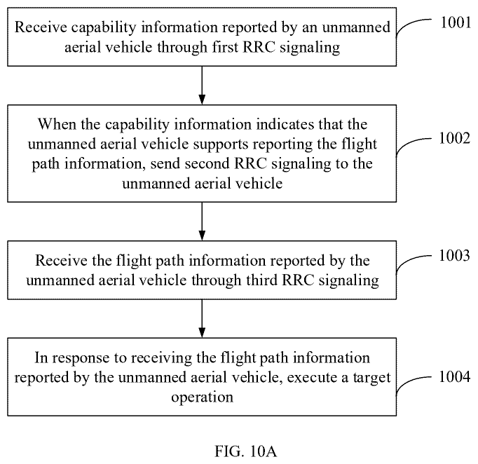

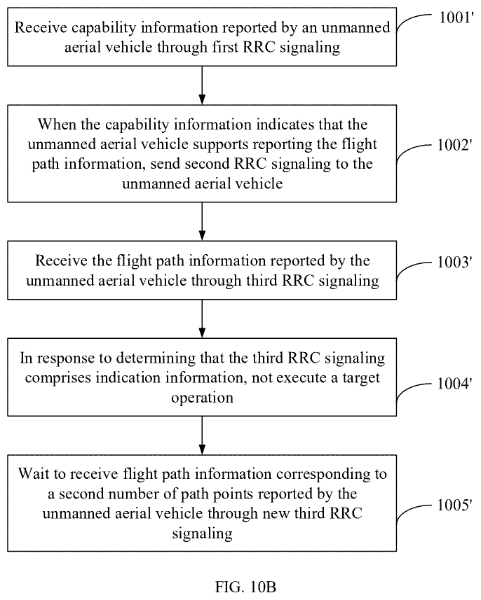

In some embodiments, with reference to FIG. 10A, FIG. 10A is a flowchart of an information transmission method according to an embodiment, which can be performed by a base station, and the method may include steps 1001-1004.

At step 1001, capability information reported by an unmanned aerial vehicle through first radio resource control (RRC) signaling is received.

At step 1002, when the capability information indicates that the unmanned aerial vehicle supports reporting the flight path information, second RRC signaling is sent to the unmanned aerial vehicle.

At step 1003, the flight path information reported by the unmanned aerial vehicle through third RRC signaling is received.

The specific implementation is similar to steps 901 to 903, and will not be described here.

At step 1004, in response to receiving the flight path information reported by the unmanned aerial vehicle, a target operation is executed.

In the embodiment of the present disclosure, as long as the base station receives the flight path information reported by the UAV, regardless of whether the flight path information corresponds to the total number of path points, it will trigger the base station to perform the target operation, which can at least include an inter-base station handover preparation operation.

In some examples, the target operation may also include other operations related to the flight path information, such as informing a neighboring base station of the flight path information, so that the neighboring base station can perform interference control and avoid affecting the data and signaling reception of the UAV, which is not limited in the present disclosure.

Thus, the base station executes the target operation every time it receives the flight path information reported by the UAV, which reduces the time delay of executing the target operation and has high usability.

In some embodiments, with reference to FIG. 10B, FIG. 10B is a flowchart of an information transmission method according to an embodiment, which can be performed by a base station, and the method may include steps 1001′-1005′.

At step 1001′, capability information reported by an unmanned aerial vehicle through first radio resource control (RRC) signaling is received.

At step 1002′, when the capability information indicates that the unmanned aerial vehicle supports reporting the flight path information, second RRC signaling is sent to the unmanned aerial vehicle.

In the embodiment of the present disclosure, the second RRC signaling carries configuration information for the unmanned aerial vehicle to report the flight path information.

At step 1003′, the flight path information reported by the unmanned aerial vehicle through third RRC signaling is received.

The specific implementation is similar to steps 901 to 903, and will not be described here.

At step 1004′, in response to determining that the indication information is included in the third RRC signaling, the target operation is not executed.

In the embodiment of the present disclosure, the base station receives the third RRC signaling, and the third RRC signaling includes the indication information to indicate that the UAV has not reported all flight path information, so the base station will not perform the target operation. The target operation may at least include an inter-base station handover preparation operation.

At step 1005′, wait to receive flight path information corresponding to a second number of path points reported by the unmanned aerial vehicle through new third RRC signaling.

The second number of path points is a difference between the total number of path points and the maximum number of path points.

Thus, when the base station determines that the UAV has not reported all the flight path information, it will not perform the target operation, so the availability is high.

In some embodiments, the method further includes the following step (not shown in FIG. 10B).

At step 1006′, in response to receiving flight path information corresponding to the total number of path points reported by the unmanned aerial vehicle, the target operation is executed.

Thus, the base station performs the target operation after receiving all the flight path information, which improves the accuracy of flight path information processing and has high usability.

Corresponding to the foregoing embodiments of the application function realization methods, the present disclosure further provides embodiments of application function realization apparatuses.

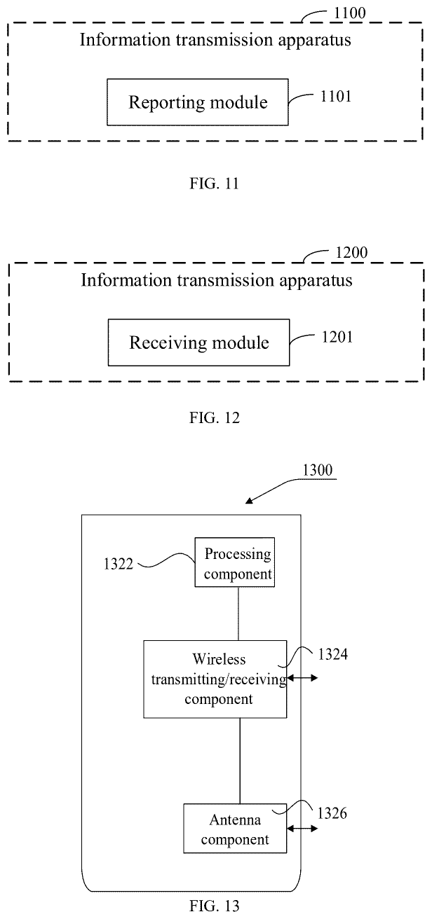

Referring to FIG. 11, FIG. 11 is a block diagram of an information transmission apparatus 1100 according to an embodiment of the present disclosure, which is applied to an unmanned aerial vehicle and includes a reporting module 1101.

The reporting module 1101 is configured to report capability information to a base station through first radio resource control (RRC) signaling, where the capability information indicates whether the unmanned aerial vehicle supports reporting flight path information of the unmanned aerial vehicle.

Referring to FIG. 12, FIG. 12 is a block diagram of an information transmission apparatus 1200 according to an embodiment of the present disclosure, which is applied to a base station and includes a receiving module 1201.

The receiving module 1201 is configured to receive capability information reported by an unmanned aerial vehicle through first radio resource control (RRC) signaling, where the capability information indicates whether the unmanned aerial vehicle supports reporting flight path information of the unmanned aerial vehicle.

For the apparatus embodiments, because they essentially correspond to the method embodiments, it is only necessary to refer to the method embodiments for the relevant part of the description. The apparatus embodiments described are only schematic, in which the units described as separate components may or may not be physically separated, and the components displayed as units may or may not be physical units, that is, they may be located in one place or distributed to multiple network units. Some or all of the modules can be selected according to actual needs to achieve the purpose of the solution of the present disclosure. It can be understood and implemented by a person of ordinary skill in the art without creative labor.

Correspondingly, the present disclosure further provides a non-transitory computer-readable storage medium, where the storage medium stores a computer program for executing any of the information transmission methods described for the unmanned aerial vehicle side.

Correspondingly, the present disclosure further provides a non-transitory computer-readable storage medium, where the storage medium stores a computer program for executing any of the information transmission methods described for the base station side.

Correspondingly, the present disclosure further provides an information transmission apparatus, including: a processor; and a memory, configured to store processor-executable instructions. Where the processor is configured to execute any of the information transmission methods described on the unmanned aerial vehicle side.

As shown in FIG. 13, FIG. 13 is a schematic structural diagram of an information transmission apparatus 1300 according to an embodiment of the present disclosure. The apparatus 1300 may be provided as an unmanned aerial vehicle. Referring to FIG. 13, the apparatus 1300 includes a processing component 1322, a wireless transmitting/receiving component 1324, an antenna component 1326, and a signal processing part unique to a wireless interface (not shown), and the processing component 1322 may further include at least one processor (not shown).

One of the processors in the processing component 1322 may be configured to perform any of the information transmission methods described for the unmanned aerial vehicle side.

Correspondingly, the present disclosure further provides an information transmission apparatus, including: a processor; and a memory, configured to store processor-executable instructions. Where the processor is configured to execute any of the information transmission methods described on the base station side.

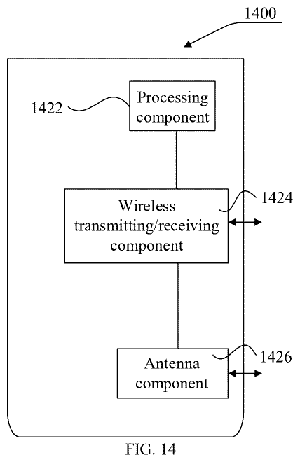

As shown in FIG. 14, FIG. 14 is a schematic structural diagram of an information transmission apparatus 1400 according to an embodiment of the present disclosure. The apparatus 1400 may be provided as a base station. Referring to FIG. 14, the apparatus 1400 includes a processing component 1422, a wireless transmitting/receiving component 1424, an antenna component 1426, and a signal processing part unique to a wireless interface (not shown), and the processing component 1422 may further include at least one processor (not shown).

One of the processors in the processing component 1422 may be configured to perform any of the information transmission methods described for the base station side.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described and shown in the accompanying drawings, and various modifications and changes can be made without departing from its scope. The scope of the present disclosure is limited only by the appended claims.

1. An information transmission method, performed by an unmanned aerial vehicle, comprising:
reporting capability information to a base station through first radio resource control (RRC) signaling, wherein the capability information indicates whether the unmanned aerial vehicle supports reporting flight path information of the unmanned aerial vehicle.

2. The method according to claim 1, wherein reporting the capability information to the base station through the first RRC signaling comprises:
reporting the capability information to the base station through a first information element in the first RRC signaling.

3. The method according to claim 2, wherein
the first RRC signaling is user equipment-evolved universal terrestrial radio access-capability (UE-EUTRA-Capability) signaling, and the first information element is an OtherParameters information element; or
the first RRC signaling is user equipment-new radio-capability (UE-NR-Capability) signaling, and the first information element is an OtherParameters information element.

4. The method according to claim 1, further comprising:
receiving second RRC signaling sent by the base station, wherein the second RRC signaling carries configuration information for the unmanned aerial vehicle to report the flight path information.

5. The method according to claim 4, wherein the configuration information indicates at least one of:
whether the unmanned aerial vehicle is allowed to report the flight path information;
a condition for reporting the flight path information;
a format for reporting the flight path information; or
a maximum number of path points allowed to be reported.

6. The method according to claim 4, wherein the configuration information is carried in a second information element of the second RRC signaling;
wherein the second RRC signaling is RRC Connection Reconfiguration (RRCConnectionReconfiguration) signaling, and the second information element is an other configuration (OtherConfig) information element; or the second RRC signaling is RRC Reconfiguration (RRCReconfiguration) signaling, and the second information element is an other configuration (OtherConfig) information element.

7. (canceled)

8. The method according to claim 5, further comprising:
on a condition that the configuration information indicates that the unmanned aerial vehicle is allowed to report the flight path information, reporting, based on the configuration information, the flight path information to the base station through third RRC signaling.

9. The method according to claim 8, wherein reporting the flight path information to the base station through the third RRC signaling comprises:
reporting the flight path information to the base station through a third information element in the third RRC signaling; wherein
the third RRC signaling is user equipment assistance information (UEAssistanceInformation) signaling, and
the third information element is a flight path information report (flightPathInfoReport) information element.

10. The method according to claim 8, wherein reporting the flight path information to the base station through third RRC signaling comprises:
reporting flight path information corresponding to a first number of path points through the third RRC signaling; wherein the first number of path points is a smaller one of a total number of path points on a flight path of the unmanned aerial vehicle and the maximum number of path points.

11. The method according to claim 10, wherein on a condition that the total number of path points is greater than the maximum number of path points, the third RRC signaling comprises indication information to indicate that the unmanned aerial vehicle does not report all flight path information; wherein the indication information is carried in a third information element of the third RRC signaling;
after reporting the flight path information corresponding to the first number of path points through the third RRC signaling, the method further comprises:
reporting flight path information corresponding to a second number of path points to the base station through new third RRC signaling, wherein the second number of path points is a difference between the total number of path points and the maximum number of path points.

12-14. (canceled)

15. An information transmission method, performed by a base station, comprising:
receiving capability information reported by an unmanned aerial vehicle through first radio resource control (RRC) signaling, wherein the capability information indicates whether the unmanned aerial vehicle supports reporting flight path information of the unmanned aerial vehicle.

16. The method according to claim 15, wherein receiving the capability information reported by the unmanned aerial vehicle through first RRC signaling comprises:
receiving the capability information reported by the unmanned aerial vehicle through a first information element in the first RRC signaling;
wherein the first RRC signaling is user equipment-evolved universal terrestrial radio access-capability (UE-EUTRA-Capability) signaling, and the first information element is an OtherParameters information element, or
the first RRC signaling is user equipment-new radio-capability (UE-NR-Capability) signaling, and the first information element is an OtherParameters information element.

17. (canceled)

18. The method according to claim 15, further comprising:
when the capability information indicates that the unmanned aerial vehicle supports reporting the flight path information, sending second RRC signaling to the unmanned aerial vehicle, wherein the second RRC signaling carries configuration information for the unmanned aerial vehicle to report the flight path information.

19. The method according to claim 18, wherein
the configuration information indicates at least one of:
whether the unmanned aerial vehicle is allowed to report the flight path information;
a condition for reporting the flight path information;
a format for reporting the flight path information; or
a maximum number of path points allowed to be reported;
wherein the configuration information is carried in a second information element of the second RRC signaling;
wherein the second RRC signaling is RRC Connection Reconfiguration (RRCConnectionReconfiguration) signaling, and the second information element is an other configuration (OtherConfig) information element; or the second RRC signaling is RRC Reconfiguration (RRCReconfiguration) signaling, and the second information element is an other configuration (OtherConfig) information element.

20-21. (canceled)

22. The method according to claim 19, further comprising:
receiving the flight path information reported by the unmanned aerial vehicle through third RRC signaling.

23. The method according 22, wherein the receiving the flight path information reported by the unmanned aerial vehicle through third RRC signaling comprises:
receiving the flight path information reported by the unmanned aerial vehicle through a third information element in the third RRC signaling; wherein the third RRC signaling is user equipment assistance information (UEAssistanceInformation) signaling, and the third information element is a flight path information report (flightPathInfoReport) information element.

24. The method according to claim 22, further comprising:
in response to receiving the flight path information reported by the unmanned aerial vehicle, executing a target operation, wherein the target operation at least comprises an inter-base station handover preparation operation.

25. The method according to claim 22, further comprising:
in response to determining that the third RRC signaling comprises indication information, wherein the indication information indicates that the unmanned aerial vehicle does not report all flight path information, and the indication information is carried in a third information element of the third RRC signaling,
waiting to receive flight path information corresponding to a second number of path points reported by the unmanned aerial vehicle through new third RRC signaling, wherein the second number of path points is a difference between a total number of path points on a flight path of the unmanned aerial vehicle and the maximum number of path points; and
in response to receiving flight path information corresponding to the total number of path points reported by the unmanned aerial vehicle, executing a target operation, wherein the target operation at least comprises an inter-base station handover preparation operation.

26-32. (canceled)

33. An information configuration apparatus, comprising:
a processor; and
a memory, configured to store processor-executable instructions,
wherein the processor is configured to:
report capability information to a base station through first radio resource control (RRC) signaling, wherein the capability information indicates whether an unmanned aerial vehicle supports reporting flight path information of the unmanned aerial vehicle.

34. An information configuration apparatus, comprising:
a processor; and
a memory, configured to store processor-executable instructions, and
wherein the processor is configured to execute the information transmission method according to claim 15.
